(19) United States
(12) Patent Application Publication
(10) Pub. No.: US 2017/0098858 A1
(43) Pub. Date: Apr. 6, 2017

(54) LITHIUM METAL BATTERY

(71) Applicants: Samsung Electronics Co., Ltd., Suwon-si (KR); Samsung SDI Co., Ltd., Yongin-si (KR)

(72) Inventors: Jusik Kim, Seongnam-si (KR); Hyunseok Kim, Suwon-si (KR); Saebom Ryu, Suwon-si (KR); Joungwon Park, Yongin-si (KR); Hyorang Kang, Anyang-si (KR); Dahye Park, Osan-si (KR); Wonseok Chang, Seoul (KR)

(21) Appl. No.: 15/221,743

(22) Filed: Jul. 28, 2016

(30) Foreign Application Priority Data
Oct. 1, 2015 (KR) 10-2015-0138618

(51) Int. Cl. H01M 10/0567; H01M 4/38; H01M 4/525; H01M 10/0569; H01M 4/62; H01M 10/0525; H01M 10/0568; H01M 4/134; H01M 4/131

(52) U.S. Cl. CPC H01M 10/0567; H01M 4/134; H01M 4/38; H01M 4/525; H01M 4/131; H01M 4/623; H01M 10/0525; H01M 10/0568; H01M 10/0569; H01M 2300/0037

(57) ABSTRACT

A lithium metal battery including: a lithium metal negative electrode; a positive electrode; and a liquid electrolyte disposed between the lithium metal negative electrode and the positive electrode, wherein the liquid electrolyte includes an ionic liquid including a cation represented by Formula 1 and an anion, and an organic solvent:

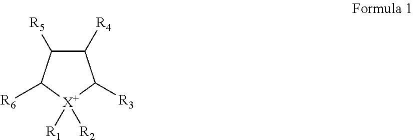

wherein in Formula 1, X and R₁ to R₆ are as defined in the present specification.

### CROSS-REFERENCE TO RELATED APPLICATION

This application claims priority to and the benefit of Korean Patent Application No. 10-2015-0138618, filed on Oct. 1, 2015, in the Korean Intellectual Property Office, and all the benefits accruing therefrom under 35 U.S.C. §119, the content of which is incorporated herein in its entirety by reference.

### BACKGROUND

1. Field

The present disclosure relates to a lithium metal battery including a negative electrode.

2. Description of the Related Art

A lithium secondary battery is a high performance secondary battery having the highest energy density among the common secondary batteries, and thus may be utilized in various fields such as electrical vehicles.

An example of the negative electrode of the lithium secondary battery may be a lithium electrode. A lithium electrode has a high electric capacity per unit weight, and thus the battery including the lithium electrode can also have a high capacity. However, the lithium secondary battery or a lithium metal battery including the lithium electrode as a negative electrode conventionally uses a liquid electrolyte such as a carbonate electrolyte or an ether electrolyte having a low viscosity. Also, the liquid electrolyte forms a porous lithium deposition layer on a lithium metal interface, and a side reaction between the electrolyte and the lithium metal may occur due to high reactivity of the electrolyte during a charging/discharging process. A highly porous lithium deposition layer formed on a lithium metal surface reduces an energy density during charging of a battery and may decrease lifespan of the lithium metal battery. Thus, there remains a need for a lithium battery having improved cell performance.

### SUMMARY

Provided is a lithium metal battery having an improved energy density and improved lifespan characteristics by increasing a density of a lithium deposition layer on a lithium negative electrode surface.

Additional aspects will be set forth in part in the description which follows and, in part, will be apparent from the description, or may be learned by practice of the presented exemplary embodiments.

According to an aspect of an exemplary embodiment, a lithium metal battery includes:

a lithium metal negative electrode;

a positive electrode; and

a liquid electrolyte disposed between the lithium metal negative electrode and the positive electrode, wherein the liquid electrolyte includes an ionic liquid including a cation that is represented by Formula 1 and an anion, and an organic solvent:

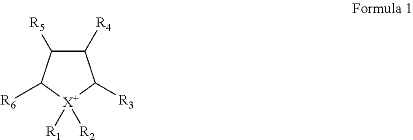

wherein in Formula 1,

X is N, P, or As;

R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ has 4 or more carbon atoms; and

R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclic alkyl group, a substituted or unsubstituted C2-C30 heterocyclicoxy group, or a substituted or unsubstituted C3-C30 heterocyclicoxyalkyl group.

Also disclosed is a method of manufacturing a lithium metal battery, the method including:

providing a positive electrode having a positive active material disposed thereon;

providing a lithium metal negative electrode;

disposing a separator between the positive electrode and the lithium metal negative electrode;

disposing the positive electrode, the separator, and the negative electrode in a battery case; and

adding a liquid electrolyte to the cell case such that it contacts the positive electrode, the lithium metal negative electrode, and a separator to manufacture the lithium metal battery,

wherein the liquid electrolyte includes
an ionic liquid including a cation represented by Formula 1 and an anion, and
an organic solvent:

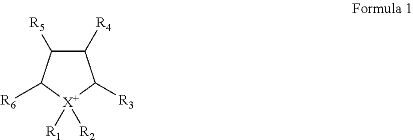

wherein in Formula 1,

X is N, P, or As;

R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ includes 4 or more carbon atoms; and
R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclicalkyl group, a substituted or unsubstituted C2-C30 heterocyclicoxy group, or a substituted or unsubstituted C3-C30 heterocyclicoxyalkyl group.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view of a lithium metal battery according to an exemplary embodiment;

FIG. 2 a graph of relative intensity (arbitrary units, a. u.) versus retention time (minutes, min) showing the results of a gel permeation chromatography (GPC) analysis performed on liquid electrolytes of Preparation Example 2 and Comparative Preparation Examples 1 and 5;

FIG. 3 is a scanning electron microscope (SEM) image of a cross-sectional view of a lithium deposition layer of a test cell using a liquid electrolyte prepared in Comparative Preparation Example 1;

FIG. 4 is an SEM image of a cross-sectional view of a lithium deposition layer of a test cell using a liquid electrolyte prepared in Preparation Example 2;

FIGS. 5A and 5B are SEM images of a deposition layer prepared in Comparative Example 1;

FIGS. 6A and 6B are SEM images of a deposition layer prepared in Example 2;

FIG. 7 is a graph of capacity (milliampere hours per gram, mAh/g) versus cycle number (number) illustrating a change in discharging characteristics per cycle of lithium metal batteries prepared in Examples 1 and 2 and Comparative Examples 1, 2, 3, and 5;

FIG. 8 is a graph of imaginary impedance, —Z″ (Ohm square centimeters, Ωcm²) versus real impedance, Z′ (Ohm square centimeters, Ωcm²) showing the results of impedance analysis of a lithium metal battery prepared in Comparative Example 1;

FIG. 9 is a graph of imaginary impedance, —Z″ (Ohm square centimeters, Ωcm²) versus real impedance, Z′ (Ohm square centimeters, Ωcm²) showing the results of impedance analysis of a lithium metal battery prepared in Example 2;

FIG. 10 is a graph of capacity (milliampere hours per gram, mAh/g) versus cycle number (number) illustrating a change in a discharge capacity per cycle of lithium metal batteries prepared in Comparative Examples 1 and 7 and Examples 2 and 3; and

FIG. 11 is a graph of imaginary impedance, —Z″ (Ohm square centimeters, Ωcm²) versus real impedance, Z′ (Ohm square centimeters, Ωcm²) showing the results of impedance analysis of lithium metal batteries prepared in Comparative Examples 1 and 7 and Example 2.

### DETAILED DESCRIPTION

Reference will now be made in detail to exemplary embodiments of a lithium metal battery, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present disclosure. As used herein, the term “and/or” includes any and all combinations of one or more of the associated listed items. Expressions such as “at least one of,” when preceding a list of elements, modify the entire list of elements and do not modify the individual elements of the list.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” As used herein, the terms such as “comprising”, “including”, “having”, or the like are intended to indicate the existence of the features regions, integers, steps, operations, components, and/or elements disclosed in the specification, and are not intended to preclude the possibility that one or more other features or elements may exist or may be added.

It will also be understood that when an element such as a layer, a region or a component is referred to as being “on” another layer or element, it can be directly on the other layer or element, or intervening layers, regions, or components may also be present. In contrast, when an element is referred to as being “directly on” another element, there are no intervening elements present.

In the drawings, the sizes of elements are exaggerated or reduced for ease of description. The size or thickness of each element shown in the drawings are arbitrarily illustrated for better understanding or ease of description, and thus the present disclosure is not limited thereto.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Hereinafter, with reference to attached drawings, an electrolyte for a secondary battery, a method of preparing the electrolyte, and a secondary battery including the electrolyte according to an exemplary embodiment will be described in detail. However, these are for illustrative purposes only and are not intended to limit the scope of this disclosure.

According to an exemplary embodiment, a lithium metal battery comprises:

a lithium metal negative electrode;

a positive electrode; and

a liquid electrolyte that is disposed between the lithium metal negative electrode and the positive electrode,

wherein the liquid electrolyte includes an ionic liquid and an organic solvent, and wherein the ionic liquid includes a cation represented by Formula 1 and an anion:

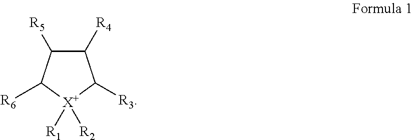

In Formula 1,

X is N, P, or As,

R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ comprises 4 or more carbon atoms; and

R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclic alkyl group, a substituted or unsubstituted C2-C30 heterocyclicoxy group, or a substituted or unsubstituted C3-C30 heterocyclicoxyalkyl group.

In general, when an ionic liquid is added to a liquid electrolyte, the ionic liquid may be used either alone as a single electrolyte or as a mixture with a carbonate electrolyte solution in a liquid phase in an amount of about 30 percent by volume (vol %) or greater to increase flame retardancy.

Also, the effects of the ionic liquid on a density of a lithium deposition layer in a lithium metal negative electrode according to a cation chain structure have not been verified. Further, when the ionic liquid has the composition described above, electrochemical safety issues may occur at a lithium metal negative electrode interface at a high voltage or a high current density. This may result in deterioration of energy density and performance of the lithium metal battery, and the cell may not be stable due to thickness expansion at a side of the lithium metal negative electrode.

On the contrary, the lithium metal battery according to an embodiment includes an ionic liquid having a pyrrolidinium cation having a substituent group with a non-polar chain structure including 4 or more carbon atoms as shown in Formula 1 in a liquid electrolyte. Such ionic liquid increases a density of a lithium deposition layer on a surface of the lithium metal negative electrode, and thus an energy density of the lithium metal battery may increase during a charging process. In this regard, an overall thickness change of the cell during a charging/discharging process may be minimized, and thus stability and life characteristics of the lithium metal battery may be improved.

When the substituent group of the non-polar chain structure of the cation of the ionic liquid has a length of 4 or more carbon atoms, a solvation volume of lithium ions in the liquid electrolyte may increase. Instead of decreasing interfacial reaction kinetics, the increase in the solvation volume of lithium ions may improve a deposition density of a lithium deposition layer by increasing nucleation and growth uniformity for lithium deposition on a surface of the lithium metal negative electrode.

Also, the ionic liquid having the pyrrolidinium cation represented by Formula 1 forms a stable lithium deposition layer at the lithium metal negative electrode interface during a charging/discharging process, and thus electrochemical stability and interfacial stability of the lithium metal battery may improve.

As used herein, the term “pyrrolidinium cation” denotes a cation of Formula 1 referring to a pyrrolidinium structure or a derivative thereof, and it is not strictly limited to a particular cation of a pyrrolidinium compound. Thus, an ionic liquid used in an embodiment, as shown in Formula 1, may include a cation having any pyrrolidinium structure including a Group V element such as N, P, or As.

In some embodiments, the cation may be a pyrrolidinium cation represented by Formula 2:

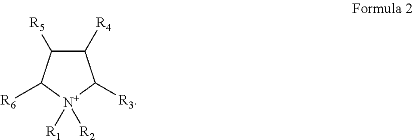

In Formula 2, R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ has 4 or more carbon atoms; and

R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclic alkyl group, a substituted or unsubstituted C2-C30 heterocyclicoxy group, or a substituted or unsubstituted C3-C30 heterocyclicoxyalkyl group.

For example, the cation may be a pyrrolidinium cation represented by Formula 2a:

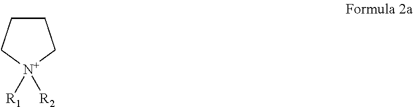

In Formula 2a,

R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ has 4 or more carbons.

In Formulas 1, 2, and 2a, at least one hydrogen atom of R₁ to R₆ may be substituted with a halogen atom, a C1-C30 alkyl group substituted with a halogen atom, a C1-C30 alkoxy group, a C2-C30 alkoxyalkyl group, a hydroxyl group, a nitro group, a cyano group, an amino group, an amidino group, a hydrazine group, a hydrazone group, a carboxylic acid or a salt thereof, a sulfonyl group, a sulfamoyl group, a sulfonic acid or a salt thereof, a phosphoric acid or a salt thereof, a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C3-C30 heteroaryloxyalkyl group, a C6-C30 heteroarylalkyloxy group, a C4-C30 carbocyclic group, a C5-C30 carbocyclicalkyl group, a C4-C30 carbocyclicoxy group, a C5-C30 carbocyclicoxyalkyl group, a C2-C30 heterocyclic group, or a C3-C30 heterocyclic alkyl group, a C2-C30 heterocyclicoxy group, or a C3-C30 heterocyclicoxyalkyl group.

For example, the at least one hydrogen atom of R₁ to R₆ may be substituted with a fluorine (—F) atom.

For example, the cation may include at least one selected from N-butyl-N-methylpyrrolidinium, N-methyl-N-pentylpyrrolidinium, N-hexyl-N-methylpyrrolidinium, N-heptyl-N-methylpyrrolidinium, N-methyl-N-octylpyrrolidinium, N-methyl-N-nonylpyrrolidinium, N-decyl-N-methylpyrrolidinium, N-methyl-N-undecylpyrrolidinium, N-dodecyl-N-methylpyrrolidinium, N-methyl-N-tridecylpyrrolidinium, N-methyl-N-tetradecylpyrrolidinium, N-methyl-N-pentadecylpyrrolidinium, N-hexadecyl-N-methylpyrrolidinium, N-heptadecyl-N-methylpyrrolidinium, N-methyl-N-octadecylpyrrolidinium, N-methyl-N-nonadecylpyrrolidinium, N-eicosyl-N-methylpyrrolidinium, N-butyl-N-ethylpyrrolidinium, N-butyl-N-propylpyrrolidinium, N,N-dibutylpyrrolidinium, N-butyl-N-pentylpyrrolidinium, N-butyl-N-hexylpyrrolidinium, N-butyl-N-heptylpyrrolidinium, N-butyl-N-octylpyrrolidinium, N-butyl-N-nonylpyrrolidinium, and N-butyl-N-decylpyrrolidinium.

In some embodiments, an amount of the cation may be in a range of greater than about 0 parts by weight to about 3 parts by weight, based on 100 parts by weight of the organic solvent. For example, an amount of the cation may be in a range of greater than about 0 parts by weight to about 2 parts by weight, based on 100 parts by weight of the organic solvent, or greater than about 0 parts by weight to about 1 part by weight, based on 100 parts by weight of the organic solvent. While not wishing to be bound by theory, it is believed that when the amount of the cation is within these ranges, a density of the lithium deposition layer increases, and lifespan characteristics of the lithium metal battery may improve. When an amount of the cation is greater than 3 parts by weight, a deposition density decreases, which may be confirmed by description in Examples of the present specification.

An anion of the ionic liquid is not particularly limited, and any suitable anion available as a counter ion with respect to the cation of the ionic liquid in the art may be used. Examples of the anion may include at least one selected from BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₃C⁻, NO₃⁻, CH₃COO⁻, Cl⁻, Br⁻, I⁻, SO₄⁻, CF₃SO₃⁻, (C₂F₅SO₂)₂N⁻, (C₂F₅SO₂)(CF₃SO₂)N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, (FSO₂)₂N⁻, and (CF₃SO₂)₂N⁻.

In some embodiments, the organic solvent may include an ether solvent. The ether solvent can have excellent deposition and desorption efficiency.

In some embodiments, the organic solvent may include: i) a high dissolution capability ether solvent in which lithium ions are soluble and ii) a fluorine substituted ether solvent represented by the following Formula 3:

R—{O(CH₂)ₐ}_{b}—CH₂—O—CₙF₂ₙH Formula 3

In Formula 3,

R is CₘF₂ₘH or CₘF₂ₘ₊₁,

n is an integer of 2 or greater,

m is an integer of 1 or greater,

a is an integer of 1 or 2, and

b is 0 or 1.

The high dissolution capability ether solvent in which lithium ions are solvated has solubility characteristics that makes it capable to dissolve a lithium salt to a high concentration, and form an ion conduction activation domain in the electrolyte. By using such an ether solvent, oxidation resistance of the electrolyte may be improved, and high-rate charge/discharge characteristics of the lithium metal battery employing the electrolyte may also be improved.

The fluorinated ether solvent forms an ion conduction inactivation domain in the electrolyte, in which a lithium salt has a very low solubility or almost no solubility. If the electrolyte contains the fluorinated ether solvent, overall viscosity of the electrolyte may be reduced, and oxidation of an ion conduction activation domain in the interface of the electrolyte may be efficiently prevented. Further, the fluorinated ether solvent may perform a role of imparting flame retardancy in such a way that a high dissolution capability ether solvent, which is relatively vulnerable to ignition, may become stabilized to exposure to high temperatures by blocking reactions of the electrolyte with active oxygen.

The fluorine substituted ether solvent may include a —CH₂—O— unit in addition to a —CₙF₂ₙH group in a molecule, wherein the —CH₂—O— unit may have oxygen with unshared electron pairs, and the oxygen may form a coordination bond with lithium. In such a case, diffusion of lithium is more facilitated, and the ion conductivity of the electrolyte may be improved. The fluorinated ether solvent having a —CF₂—O— unit instead of a —CH₂—O— unit beside a —CₙF₂ₙH group may make diffusion of lithium difficult compared to the compound of Formula 1 having the —CH₂—O— unit due to an electron accepting CF₂ group in which unshared electron pairs of oxygen are adjacent to each other.

In some embodiments, an amount of the fluorine substituted ether solvent represented by Formula 3 may be greater than that of the high dissolution capability ether solvent in which lithium ions are solvated. If an amount of the fluorine substituted ether solvent represented by the Formula 3 is less than or the same as that of the high dissolution capability ether solvent in which lithium ions are soluble, it may be difficult to obtain the electrolyte having suitable high voltage stability and flame retardancy, or it may be difficult to obtain suitable ion conductivity due to a substantially high viscosity of the electrolyte.

The high dissolution capability ether solvent in which lithium ions are solvated may be contained in an amount of about 15% by volume to about 45% by volume, e.g., about 20% by volume to about 40%, or about 25% by volume to about 35% by volume, based on the total volume of the high dissolution capability ether solvent and fluorine substituted ether solvent. While not wishing to be bound by theory, it is understood that when the ether solvent is in the above amount ranges, the electrolyte may have excellent ion conductivity.

The fluorine substituted ether solvent may be contained in an amount of about 55% by volume to about 85% by volume, e.g., about 60% by volume to about 85%, or about 65% by volume to about 85% by volume, based on the total volume of the high dissolution capability ether solvent and fluorine substituted ether solvent. While not wishing to be bound by theory, it is understood that when the fluorine substituted ether solvent is in the above amount range, the electrolyte is prepared easily, and the electrolyte may have an excellent ion conductivity without deteriorating oxidation resistance or flame retardancy of the lithium metal battery, or without the viscosity value of the electrolyte becoming too high.

When the high dissolution capability ether solvent in which lithium ions are solvated and the fluorine substituted ether solvent represented by Formula 3 are used, an amount of a lithium salt increases which causes ion conductivity (high-rate) characteristics to improve according to concentration gradient minimization generated during a charging process. Thus, chances of the solvent molecules to contact the lithium metal negative electrode decrease, thereby reducing a side product layer formed by a reduced product of a solid electrolyte interphone (SEI) layer and an electrolyte. Therefore, a content of the lithium salt in the lithium metal battery according to an embodiment may be in a range of about 0.1 molar (M) to about 7 M, about 0.5 molar (M) to about 5 M, or about 1 molar (M) to about 3 M, and the amount of solvent may be reduced during a charging process, which may prevent formation of the SEI layer on a surface of the lithium metal negative electrode.

The fluorine substituted ether solvent represented by Formula 3 influences flame retardancy and oxidation resistance of electrolyte. The fluorine substituted ether solvent is added in the electrolyte so that a porous thin film-shaped SEI is formed on the surface of the negative electrode to result in suppressing additional reduction reactions of the electrolyte, preventing oxidation of the electrolyte on the interface with a lithium negative electrode, improving flame retardancy of the electrolyte, and lowering viscosity of the electrolyte to about 5 centipoises (cP) or lower even at high concentration values of the a lithium salt. The fluorine substituted ether solvent of Formula 3 minimizes oxidation of the electrolyte at the positive electrode side, lowers viscosity of the electrolyte, effectively imparts flame retardancy to the electrolyte, and greatly influences electrolyte viscosity. When the electrolyte according to an embodiment is used, flame retardancy and safety, e.g., high voltage safety of the battery is improved, and the battery has high energy density characteristics without forming decomposition products of the electrolyte on interface between the lithium negative electrode and the electrolyte.

Further, the high dissolution capability ether solvent in which lithium ions are solvated may dissolve a high concentration lithium salt. The high dissolution capability ether solvent may be capable of solving a lithium salt in an amount of about 0.1 M to about 7 M, for example, about 0.2 M to about 7 M, or about 0.5 M to about 5 M. An ether which can dissolve LiPF₆ in an amount of about 0.1 M to about 7 M, is specifically mentioned.

Therefore, the lithium metal battery using the electrolyte including the high dissolution capability ether solvent has improved ion conductivity and also improved oxidation resistance and high-rate charge/discharge characteristics obtained by dissolving a high concentration lithium salt.

Since the fluorine substituted ether solvent represented by Formula 3 has electron withdrawing groups, it is strongly resistant to oxidation. Therefore, the fluorine substituted ether solvent represented by Formula 3 may prevent oxidation of the electrolyte that may occur from the positive electrode side at high voltages during charging.

As a result, the fluorine substituted ether solvent represented by Formula 3 may form an SEI layer on the negative electrode surface, and the fluorine substituted ether solvent represented by Formula 3 has an improved stability, namely improved lifetime characteristics, high-rate charge/discharge characteristics, and safety of the lithium metal battery may be improved at high voltage values.

In Formula 3, R is —CF₂CF₂H, —CF₂CF₂CF₂H, —CF₂CF₂CF₂CF₂H, or CF₃, and CₙF₂ₙH is —CF₂CF₂H, —CF₂CF₂CF₂H, or —CF₂CF₂CF₂CF₂H.

The fluorine substituted ether solvent may be a compound represented by the following Formula 4:

R—CH₂—O—CₙF₂ₙH. Formula 4

In Formula 4,

R is Cₘ₊₁HₘF₂ₘ or CₘF₂ₘ₊₁,

n is an integer of 2 to 5, and

m is an integer of 1 to 5.

The fluorine substituted ether solvent represented by Formula 4 may be at least one selected from HCF₂CF₂CH₂OCF₂CF₂H, HCF₂CF₂CH₂OCF₂CF₂CF₂CF₂H, HCF₂CF₂OCH₂CF₃, HCF₂CF₂OCH₂CH₂OCF₂CF₂H, HCF₂CF₂OCH₂CH₂OCF₂CF₂H, HCF₂CF₂OCH₂CH₂CH₂OCF₂CF₂H, HCF₂CF₂CH₂OCF₂CF₂CF₂H, HCF₂CF₂OCH₂CH₂OCF₂CF₂CF₂H, and HCF₂CF₂OCH₂CH₂CH₂OCF₂CF₂CF₂H. Since such fluorine substituted ether solvent has a low polarity, a possibility that impurities may be dissolved and may contaminate the electrolyte containing the fluorine substituted ether solvent is low.

Since the fluorine substituted ether solvent used in the electrolyte has a high flash point of about 80° C. or greater, the electrolyte has improved flame retardancy, and high temperature stabilities of the battery may be improved. Further, the fluorine substituted ether solvent is low in polarity and has a structure in which fluorine substituted functional groups are bonded to the —CH₂—O— moiety. Therefore, such a fluorine substituted ether solvent mixes very well with the high dissolution capability ether solvent in which lithium ions are solvated, such as dimethyl ether (DME).

For example, the high dissolution capability ether solvent in which lithium ions are solvated may be a glyme solvent.

The high dissolution capability ether solvent in which lithium ions are solvated may be at least one selected from ethylene glycol dimethyl ether (1,2-dimethoxyethane), ethylene glycol diethyl ether (1,2-diethoxyethane), propylene glycol dimethyl ether, propylene glycol diethyl ether, butylene glycol dimethyl ether, butylene glycol diethyl ether, diethylene glycol dimethyl ether, triethylene glycol dimethyl ether, tetraethylene glycol dimethyl ether, diethylene glycol diethyl ether, triethylene glycol diethyl ether, tetraethylene glycol diethyl ether, dipropylene glycol dimethyl ether, tripropylene glycol dimethyl ether, tetrapropylene glycol dimethyl ether, dipropylene glycol diethyl ether, tripropylene glycol diethyl ether, tetrapropylene glycol diethyl ether, dibutylene glycol dimethyl ether, tributylene glycol dimethyl ether, tetrabutylene glycol dimethyl ether, dibutylene glycol diethyl ether, tributylene glycol diethyl ether, tetrabutylene glycol diethyl ether, poly(ethyleneglycol) dilaurate (PEGDL), poly(ethyleneglycol) monoacrylate (PEGMA), and poly(ethyleneglycol) diacrylate (PEGDA).

The electrolyte may have a viscosity in the range of about 5 centipoise (cP) or less for example, about 4 cP or less, about 3 cP or less, about 2 cP or less, or about 1 cP or less at 25° C., for example about 5 cP to about 0.1 cP, or about 4 cP to about 0.5 cP. When the viscosity of the electrolyte is in the above ranges, ions are moved freely within the electrolyte, and ion conductivity of the electrolyte is suitable.

In some embodiments, the liquid electrolyte may further include a lithium salt.

Any suitable lithium salt that is used to prepare an electrolyte in the art may be used. Examples of the lithium salt may include at least one selected from LiSCN, LiN(CN)₂, LiClO₄, LiBF₄, LiAsF₆, LiPF₆, LiCF₃SO₃, Li(CF₃SO₂)₂N, Li(CF₃SO₂)₃C, LiSbF₆, LiN(SO₂CF₃)₂, Li(FSO₂)₂N, LiC₄F₉SO₃, LiN(SO₂CF₂CF₃)₂, LiSbF₆, LiPF₃(CF₂CF₃)₃, LiPF₃(C₂F₅)₃, LiPF₃(CF₃)₃, LiCl, LiF, LiBr, LiI, LiB(C₂O₄)₂, lithium difluoro(oxalato)borate (LiFOB), and lithium bis(oxalato)borate (LiBOB).

The lithium salt according to an embodiment is a fluorine-containing sulfone compound. Examples of fluorine-containing sulfone imide compound may include at least one selected from LiN(FSO₂)₂(LiFSI), LiN(CF₃SO₂)₂(LiTFSI), LiN(CF₂SO₂)(CF₃CF₂CF₂CF₂SO₂), LiN(CF₃CF₂SO₂)₂, LiC(CF₃SO₂)₂, and LiC(CF₃CF₂SO₂)₂.

An amount of the lithium salt may be in a range of about 0.1 M to about 7 M, for example, about 1 M to about 7 M, or about 3 M to about 5 M, based on the liquid electrolyte. While not wishing to be bound by theory, it is understood that when the amount of the lithium salt is within the above ranges, lifespan characteristics of a lithium metal battery improve without an increase in an internal resistance of the electrolyte.

A viscosity of the liquid electrolyte may be about 5 cP or less at 25° C., e.g., about 2.5 cP to about 4 cP. While not wishing to be bound by theory, it is understood that when the viscosity of the electrolyte is within the above ranges, a conductivity and an anti-oxidant property of the electrolyte are excellent, and a lithium metal battery including the electrolyte may have high voltage and improved stability.

An ion conductivity of the electrolyte at 25° C. is about 1 milliSiemens per centimeter (mS/cm) or greater, or, for example, in a range of about 1 mS/cm to about 10 mS/cm, or about 1 mS/cm to about 5 mS/cm.

The liquid electrolyte according to an embodiment may additionally include at least one selected from selected from ethylene carbonate, propylene carbonate, dimethyl carbonate, diethyl carbonate, butylene carbonate, ethylmethyl carbonate, fluoroethylene carbonate, methylpropyl carbonate, ethylpropyl carbonate, methylisopropyl carbonate, dipropyl carbonate, dibutyl carbonate, gamma butyrolactone, dimethylene glycol dimethyl ether, trimethylene glycol dimethyl ether, tetraethylene glycol dimethyl ether, polyethylene glycol dimethyl ether, succinonitrile, dimethyl sulfone, ethylmethyl sulfone, diethyl sulfone, adiponitrile, 1,1,2,2-tetrafluoroethyl 2,2,3,3-tetrafluoropropyl ether, 2,2,3,3,4,4,5,5-octafluoropentyl-1,1,2,2-tetrafluoroethyl ether, benzonitrile, acetonitrile, tetrahydrofuran, 2-methyltetrahydrofuran, γ-butyrolactone, dioxolane, 4-methyldioxolane, N,N-dimethylformamide, N,N-dimethylacetamide, dimethyl sulfoxide, dioxane, sulfolane, dichloroethane, chlorobenzene, and nitrobenzene.

For the purpose of improving charge/discharge characteristics, flame retardancy and other properties of the liquid electrolyte, pyridine, triethyl phosphate, triethanolamine, cyclic ether, ethylene diamine, n-glyme, hexamethyl phosphoramide, nitrobenzene derivatives, sulfur, quinine imine dyes, N-substituted oxazolidinone, N,N-substituted imidazolidine, ethylene glycol dialkyl ether, ammonium salts, pyrrole, 2-methoxy ethanol, aluminum trichloride and so on may be added thereto. In some cases, the electrolyte may additionally include a halogen-containing solvent such as carbon tetrachloride and ethylene trifluoride in order to impart non-flammability to the liquid electrolyte.

The liquid electrolyte in the lithium metal battery according to embodiments may include: i) DME as a high dissolution capability ether solvent in which lithium ions are solvated, ii) TTE (HCF₂CF₂CH₂OCF₂CF₂H) or OTE (HCF₂CF₂CH₂OCF₂CF₂CF₂CF₂H) as a fluorine substituted ether solvent, and iii) LiFSI or LiTFSI as a lithium salt. Here, i) DME and ii) TTE or OTE may be mixed in a ratio of about 40:60 (1:1.5) to 20:80 (1:4) by volume. The lithium salt, LiFSI or LiTFSI, is contained in an amount ranging from about 1 M to about 6 M, for example, about 1 M to about 5 M, about 1 M to about 4 M, or about 1 M to about 3 M.

The organic solvent in the electrolyte may further include a low boiling point solvent. The low boiling point solvents are solvents having a boiling point range of about 200° C. or lower, for example, about 180° C. or lower, or about 150° C. or lower at 25° C. and an atmospheric pressure.

For example, the organic solvents may include a dialkyl carbonate, a cyclic carbonate, a linear or cyclic ester, a linear or cyclic amide, an aliphatic nitrile, a linear or cyclic ether, and any derivative thereof.

Although examples of the organic solvents may include dimethyl carbonate (DMC), ethylmethyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC), butylene carbonate, ethyl propionate, ethyl butyrate, acetonitrile, succinonitrile, dimethyl sulfoxide, dimethyl formamide, dimethyl acetamide, γ-valerolactone, γ-butyrolactone, and tetrahydrofuran, the organic solvent is not limited thereto, and any suitable low boiling organic solvent may be used.

The lithium metal battery may include a lithium deposition layer formed on a surface of the lithium metal negative electrode, and a density of the lithium deposition layer may increase by adding an ionic liquid having a pyrrolidinium cation represented by Formula 1.

In some embodiments, a deposition density of the lithium deposition layer calculated as defined in Equation 1 may be 30% or greater.

$${ρ}_{d} = \frac{{d}_{th}}{{d}_{re}} 100 \qquad Equation 1$$

In Equation 1,

ρ_{d} is a deposition density (percent, %) with respect to a lithium theoretical density of the lithium deposition layer,

dₜₕ is a theoretical thickness of the lithium deposition layer,

dᵣₑ is an actual thickness of the lithium deposition layer, and

dₜₕ is calculated according to Equation 2:

$${d}_{th} = \frac{{C}_{d}}{{C}_{th}} \frac{1}{{ρ}_{th} A} . \qquad Equation 2$$

In Equation 2,

Cₜₕ is a theoretical capacity of a lithium metal, which is 3,860 milliampere hours per gram (mAh/g),

ρₜₕ is a theoretical density of a lithium metal, which is 0.53 grams per cubic centimeter (g/cc),

A is a deposition area (square centimeters, cm²), and

C_{d} is a deposition capacity (milliampere hours, mAh).

Types of lithium metal battery are not particularly limited and may include a lithium primary battery as well as a lithium secondary battery such as a lithium ion battery, a lithium ion polymer battery, or a lithium sulfur battery.

The lithium metal negative electrode may be a lithium thin film or a lithium alloy electrode.

The lithium alloy may include a metal/metalloid that is alloyable with lithium. Examples of the metal/metalloid that is alloyable with lithium may include at least one selected from Si, Sn, Al, Ge, Pb, Bi, Sb, Si—Y′ alloys (Y′ is at least one selected from an alkali metal, alkaline earth metals, a Group 13 element, a Group 14 element, a transition metal, and a rare earth element, with Y′ not being Si), a Sn—Y″ alloys (Y″ is at least one selected from an alkali metal, alkaline earth metal, a Group 13 element, a Group 14 element, a transition metal, and a rare earth element, with Y″ not being Sn). Examples of the element Y′ and Y″ may include at least one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, and Po.

The lithium metal battery has improved stabilities at a high voltage range of about 4.35 V or greater, e.g., about 4.4 V to about 4.5 V.

The lithium metal battery according to an embodiment may be manufactured by forming a lithium deposition layer having a jelly bean shaped morphology to a thickness of about 10 micrometers (μm) to about 30 μm, e.g., about 20 μm to about 30 μm, or about 20 μm, on the surface of the lithium negative electrode after performing a charging and discharging process for 20 to 30 cycles under charge/discharge conditions of 0.5 C at about 3 V to about 4.4 V.

For example, the lithium metal battery may be manufactured by the following method.

First, a positive electrode is prepared.

For example, a positive active material composition in which a positive active material, a conducting agent, a binder, and a solvent are mixed is prepared. The positive active material composition is directly coated on a metal current collector to manufacture a positive electrode plate. Alternatively, after the positive active material composition is cast onto a separate support, a film delaminated from the support is laminated on a metal current collector to manufacture a positive electrode plate. The positive electrode is not limited to the above listed forms, and the positive electrode may be formed in other forms in addition to the above-mentioned forms.

Any suitable lithium complex oxide material known in the art may be used without limitation as the positive active material.

Examples of the positive active material may include at least one selected from a complex oxide of lithium with at least one metal selected from cobalt, manganese, and nickel. For example, the positive electrode active material may be a compound represented by at least one selected from: LiₐAl_{1-b}B′_{b}D′₂ (wherein 0.90≦a≦1.8 and 0≦b≦0.5); LiₐE_{1-b}B′_{b}O_{2-c}D′_{c} (wherein 0.90≦a≦1.8, 0≦b≦0.5, and 0≦c≦0.05); LiE_{2-b}B′_{b}O_{4-c}D′_{c} (wherein 0≦b≦0.5 and 0≦c≦0.05); LiₐNi_{1-b-c}Co_{b}B′_{c}O_{2-α}F′_{α} (wherein 0.90≦a≦1.8, 0≦b≦0.5, 0≦c≦0.05, and 0<α≦2); LiₐNi_{1-b-c}Co_{b}B′_{c}O_{2-α}F′_{α} (wherein 0.90≦a≦1.8, 0≦b≦0.5, 0≦c≦0.05, and 0<α<2); LiₐNi_{1-b-c}Co_{b}B′_{c}O_{2-α}F′₂ (wherein 0.90≦a≦1.8, 0≦b≦0.5, 0≦c≦0.05, and 0<α<2); LiₐNi_{1-b-c}Mn_{b}B′_{c}D′_{α} (wherein 0.90≦a≦1.8, 0≦b≦0.5, 0≦c≦0.05, and 0≦α≦2); LiₐNi_{1-b-c}Mn_{b}B′_{c}O_{2-α}F′_{α} (wherein 0.90≦a≦1.8, 0≦b≦0.5, 0≦c≦0.05, and 0≦α≦2); LiₐNi_{1-b-c}Mn_{b}B′_{c}O_{2-α}F′₂ (wherein 0.90≦a≦1.8, 0≦b≦0.5, 0≦c≦0.05, and 0≦α≦2); LiₐNi_{b}E_{c}G_{d}O₂ (wherein 0.90≦a≦1.8, 0≦b≦0.9, 0≦c≦0.5, and 0.001≦d≦0.1); LiₐNi_{b}CO_{c}Mn_{d}GₑO₂ (wherein 0.90≦a≦1.8, 0≦b≦0.9, 0≦c≦0.5, 0≦d≦0.5, and 0.001≦e≦0.1); LiₐNiG_{b}O₂(wherein 0.90≦a≦1.8 and 0.001≦b≦0.1); LiₐCoG_{b}O₂(wherein 0.90≦a≦1.8 and 0.001≦b≦0.1); LiₐMnG_{b}O₂(wherein 0.90≦a≦1.8 and 0.001≦b≦0.1); LiₐMn₂G_{b}O₄ (wherein 0.90≦a≦1.8 and 0.001≦b≦0.1); QO₂; QS₂; LiQS₂; V₂O₅; LiV₂O₅; LiI′O₂; LiNiVO₄; Li_{(3-f)}J₂(PO₄)₃ (wherein 0≦f≦2); Li_{(3-f)}Fe₂(PO₄)₃(wherein 0≦f≦2); and LiFePO₄.

In the foregoing Formulas, A is at least one selected from Ni, Co, and Mn; B′ is at least one selected from Al, Ni, Co, Mn, Cr, Fe, Mg, Sr, V, and a rare earth element; D′ is at least one selected from O, F, S, and P; E is at least one selected from Co, and Mn; F′ is at least one selected from F, S, and P; G is at least one selected from Al, Cr, Mn, Fe, Mg, La, Ce, Sr, and V; Q is at least one selected from Ti, Mo, and Mn; I′ is at least one selected from Cr, V, Fe, Sc, and Y; and J is at least one selected from V, Cr, Mn, Co, Ni, and Cu.

For example, the positive active material may be LiCoO₂, LiMnₓO₂ₓ (wherein x is 1 or 2), LiNi₁₋ₓMnₓO₂ₓ (wherein 0<x<1), LiNi_{1-x-y}CoₓMn_{y}O₂(wherein 0≦x≦0.5 and 0≦y≦0.5), or LiFePO₄.

A coating layer formed on the surface of the compound, or a mixture of the compound and compounds having coating layers may be used. The coating layers may include coating an element compound such as an oxide and hydroxide of the coating element, oxyhydroxide of the coating element, oxycarbonate of the coating element, and hydroxy carbonate of the coating element. The compound forming the coating layers may be amorphous or crystalline. Examples of the coating elements included in the coating layers may include at least one selected from Mg, Al, Co, K, Na, Ca, Si, Ti, V, Sn, Ge, Ga, B, As, and Zr. If a coating layer-forming process may be performed by a method such as a spray coating method, a dipping method and so on, which does not adversely affect physical properties of the positive electrode active material by using such an element in the compound, any suitable coating method may be used. Since details of the coating method can be determined by one of skill in the art without undue experimentation, a further detailed description of it is omitted here.

In order to obtain a high density lithium metal battery, it is advantageous to use a high density positive electrode. LiCoO₂ is used when manufacturing the high density positive electrode.

Examples of the conducting agent may include: at least one selected from carbon black, graphite such as natural graphite or artificial graphite, acetylene black, Ketjen black, carbon fiber, carbon nanotube, metal powder, a metal fiber or a metal tube comprising copper, nickel, aluminum, or silver; and a conductive polymer such as a polyphenylene derivative. However, the conducting agent is not limited to these examples, and the examples of the conducting agent may include any suitable material for a conducting agent in the art in.

Examples of the binder may include at least one selected from a vinylidene fluoride/hexafluoropropylene copolymer, polyvinylidene fluoride, polyimide, polyethylene, polyester, polyacrylonitrile, polymethyl methacrylate, polytetrafluoroethylene (PTFE), carboxymethyl cellulose/styrene-butadiene rubber (SMC/SBR) copolymers, and styrene butadiene rubber-based polymers. However, the binder is not limited to these examples, and the examples of the binder may include any suitable material used as a binder in the art.

Examples of the solvent may include at least one selected from N-methylpyrrolidone (NMP), acetone, and water. However, the solvent is not limited to these examples, and any suitable solvent may be used.

The positive active material, conducting agent, binder and solvent are contained in an amount that is ordinarily used in the lithium metal battery. Depending on the use and composition of the lithium metal battery, at least one of the conducting agent, the binder and the solvent may not be omitted if desired.

Next, a lithium metal thin film or a lithium alloy thin film as a lithium metal negative electrode is prepared.

Next, a separator that is interposed between the positive electrode and the lithium metal negative electrode is prepared.

A dielectric thin film having high ion permeability and mechanical strength may be used as the separator. The separator may have a pore diameter of about 0.01 μm to about 10 μm, and may have has a thickness of about 5 μm to about 20 μm. Examples of the separator may include a sheet, a non-woven fabric, and other products formed from an olefin polymer such as at least one selected from polypropylene, a glass fiber, and polyethylene. When a solid polymer electrolyte is used as the electrolyte, the solid polymer electrolyte may also be used as the separator.

Examples of the separator may include: a multi-layer including two or more layers of at least one selected from polyethylene, polypropylene, and polyvinylidene fluoride; and a mixed multi-layer such as a polyethylene/polypropylene double layer separator, a polyethylene/polypropylene/polyethylene triple layer separator, a polypropylene/polyethylene/polypropylene triple layer separator.

An electrolyte according to an embodiment is used as an electrolyte in a lithium metal battery.

A lithium metal battery according to an embodiment may additionally include at least one selected from selected from a liquid electrolyte, a solid electrolyte, a gel electrolyte, and a polymer ionic liquid.

A lithium metal battery according to other embodiment may additionally include at least one selected from a liquid electrolyte, a solid electrolyte, a gel electrolyte and a polymer ionic liquid, and a separator.

The liquid electrolyte additionally includes at least one selected from an organic solvent, an ionic liquid, and a lithium salt.

Any suitable material that is used as the organic solvent in the lithium metal battery may be used as the organic solvent. Non-limiting examples of the organic solvent may include a carbonate compound, a glyme compound, a dioxolane compound, etc.

Examples of the carbonate solvent may include at least one selected from ethylene carbonate, propylene carbonate, dimethyl carbonate, fluoroethylene carbonate, diethyl carbonate, and ethylmethyl carbonate.

Examples of the glyme solvent may include at least one selected from poly(ethylene glycol) dimethyl ether (PEGDME, polyglyme), tetra(ethylene glycol) dimethyl ether (TEGDME, tetraglyme), tri(ethylene glycol) dimethyl ether (triglyme), poly(ethylene glycol) dilaurate (PEGDL), poly(ethylene glycol) monoacrylate (PEGMA), and poly(ethylene glycol) diacrylate (PEGDA).

Examples of the dioxolane based compound may include at least one selected from 3-dioxolane, 4,5-diethyl-dioxolane, 4,5-dimethyl-dioxolane, 4-methyl-1,3-dioxolane, and 4-ethyl-1,3-dioxolane.

Examples of the organic solvent may include 2,2-dimethoxy-2-phenylacetophenone, dimethoxyethane, diethoxyethane, tetrahydrofuran, gamma butyrolactone, etc.

The gel electrolyte is a gel-shaped electrolyte, and the gel electrolyte may include any gel electrolyte material well-known in the art.

For example, the gel electrolyte may contain a polymer and a polymer ionic liquid.

For example, the polymer may be a solid graft (block) copolymer electrolyte.

The solid electrolyte may be an organic solid electrolyte or an inorganic solid electrolyte.

Examples of the organic solid electrolyte may include at least one selected from a polyethylene derivative, a polyethylene oxide derivative, a polypropylene oxide derivative, a phosphate ester polymer, polyester sulfide, polyvinyl alcohol, polyvinylidene fluoride, and a polymer including an ionic dissociative group.

Examples of the inorganic solid electrolyte may include at least one selected from Cu₃N, Li₃N, LiPON, Li₃PO₄.Li₂S.SiS₂, Li₂S.GeS₂.Ga₂S₃, (Na, Li)₁₊ₓTi₂₋ₓAlₓ(PO₄)₃ (wherein 0.1≦x≦1.9), Li₁₊ₓHf₂₋ₓAlₓ(PO₄)₃ (wherein 0.1≦x≦1.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, NLi_{0.3}La_{0.5}TiO₃, Na₅MSi₄O₁₂ (wherein M is rare earth elements such as Nd, Gd, and Dy), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (wherein 0≦y≦1.0, and M is Nd, Sm, Eu, Gd, Tb, Dy, Ho, Er, Tm, or Yb), Li_{1+x+y}QₓTi₂₋ₓSi_{y}P_{3-y}O₁₂ (wherein 0<x≦0.4, 0<y≦0.6, and Q is Al or Ga), Li₆BaLa₂Ta₂O₁₂, Li₇La₃Zr₂O₁₂, Li₅La₃Nb₂O₁₂, Li₅La₃M₂O₁₂ (M is Nb or Ta), and Li₇₊ₓAₓLa₃₋ₓZr₂O₁₂ (wherein 0<x<3 and A is Zn).

The polymer ionic liquid may be, for example, a polymerization product of ionic liquid monomers, or a polymeric compound. The polymer ionic liquid is highly soluble in an organic solvent, and thus may further improve the ionic conductivity of the electrolyte when further added.

When the polymer ionic liquid is obtained by polymerizing the above-described ionic liquid monomers, the polymer ionic liquid is prepared such that it has appropriate anions which are capable of imparting solubility with respect to an organic solvent through an anion substitution reaction after subjecting a polymerization reaction-completed product to cleaning and drying processes.

The polymer ionic liquid according to an exemplary embodiment may include a repeating unit including:

i) at least one cation selected from an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, and a triazole-based cation,
ii) at least one anion at least one selected from BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO₃⁻, (C₂F₅SO₂)₂N⁻, (C₂F₅SO₂)(CF₃SO₂)N⁻, NO₃⁻, Al₂Cl₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, and (O(CF₃)₂C₂(CF₃)₂O)₂PO⁻.

A polymer ionic liquid according to other embodiment may be prepared by polymerizing ionic liquid monomers. The ionic liquid monomers may comprise an anion and at least one cation selected from an ammonium based cation, a pyrrolidinium based cation, a pyridinium based cation, a pyrimidinium based cation, an imidazolium based cation, a piperidinium based cation, a pyrazolium based cation, an oxazolium based cation, a pyridazinium based cation, a phosphonium based cation, a sulfonium based cation, and a triazole based cation, which has a functional group that is capable of polymerizing with a vinyl group, an allyl group, an acrylate group, a methacrylate group, etc.

The ionic liquid monomers may comprise, for example, at least one selected from 1-vinyl-3-ethylimidazolium bromide, a compound represented by the following Formula 5, and a compound represented by the following Formula 6:

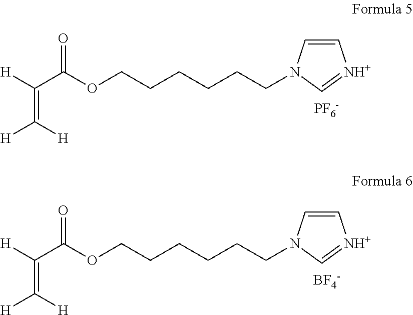

The above-described polymer ionic liquid may be, for example, a compound represented by the following Formula 7 or a compound represented by the following Formula 8:

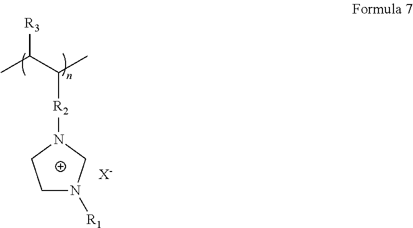

wherein in Formula 7,

R₁ and R₃ each independently is hydrogen, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₆-C₃₀ aryl group, a substituted or unsubstituted C₂-C₃₀ heteroaryl group, or a substituted or unsubstituted C₄-C₃₀ carbocyclic group,

R₂ is a single bond, a C₁-C₃ alkylene group, a C₆-C₃₀ arylene group, a C₂-C₃₀ heteroarylene group, or a C₄-C₃₀ carbocyclic group,

X⁻ represents an anion of an ionic liquid, and

n may be from 500 to 2,800; and

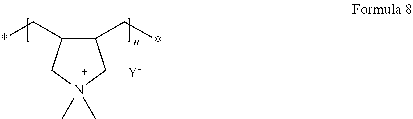

In Formula 8,

Y⁻ is the same as X⁻ in Formula 6,

n may be from 500 to 2,800, and

Y⁻ is bis(trifluoromethanesulfonyl)imide (TFSI), BF₄, or CF₃SO₃.

Examples of the polymer ionic liquid may include at least one cation selected from a poly(1-vinyl-3-alkylimidazolium) cation, a poly(1-allyl-3-alkylimidazolium) cation, and a (poly(1-(methacryloyloxy)-3-alkylimidazolium) cation, and at least one anion selected from CH₃COO⁻, CF₃COO⁻, CH₃SO₃⁻, CF₃SO₃⁻, (CF₃SO₂)₂N⁻, (FSO₂)₂N⁻, CF₃SO₂)₃C⁻, (CF₃CF₂SO₂)₂N⁻, C₄F₉SO₃⁻, C₃F₇COO⁻, and (CF₃SO₂)(CF₃CO)N⁻.

Examples of compounds represented by Formula 7 may include poly(diallyldimethylammonium bis(trifluoromethanesulfonyl)imide).

Examples of a polymer ionic liquid according to other embodiment may include a low molecular weight polymer, a thermally stable ionic liquid, and a lithium salt. The low molecular weight polymer may have an ethylene oxide chain. The low molecular weight polymer may be a glyme. Here, examples of the glyme may include polyethylene glycol dimethyl ether (polyglyme), tetraethylene glycol dimethyl ether (tetraglyme), and triethylene glycol dimethyl ether (triglyme).

The low molecular weight polymer may have a weight average molecular weight of about 75 to about 2,000, e.g., about 150 to about 1,000, or about 250 to about 500.

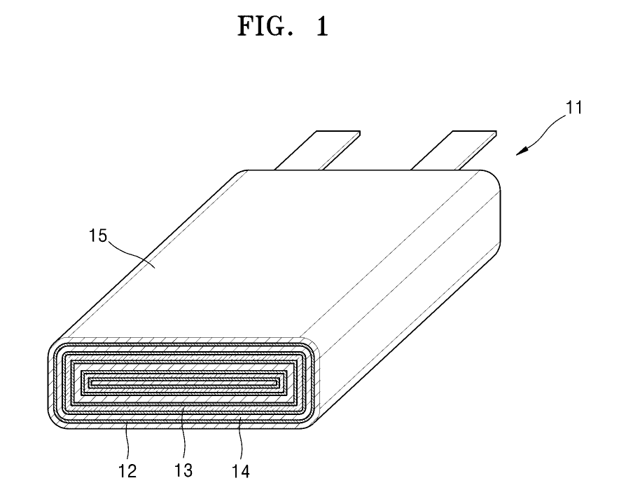

As shown in FIG. 1, the lithium metal battery 11 includes a positive electrode 13, a lithium negative electrode 12, and a separator 14. The positive electrode 13, the negative electrode 12 and the separator 14 are wound or folded before they are accommodated into a battery case 15. Subsequently, an electrolyte according to an embodiment is injected into the battery case 15, and the battery case 15 containing the electrolyte is sealed by a cap assembly 16 to complete the lithium metal battery 11. Examples of the battery case may include a cylindrical battery case, a rectangular battery case, a thin film type battery case. For example, the lithium metal battery may be a large thin film type battery. The lithium metal battery may be a lithium ion battery.

The lithium metal battery may be used in electric vehicles (EVs) since the lithium metal battery is excellent in lifetime characteristics and high-rate characteristics. For example, the lithium metal battery may be used in hybrid vehicles such as plug-in hybrid electric vehicles (PHEVs), etc. Further, the lithium metal battery may be used in fields in which storage of a large amount of electric power is required. For example, the lithium metal battery may be used in electric bicycles, electric tools.

For purposes of interpreting this specification, definitions of substituent groups used in formulas apply as follows.

As used herein, the term “alkyl” refers to a fully saturated branched or unbranched (or straight chain or linear) hydrocarbon. Examples of the “alkyl” group may include methyl, ethyl, n-propyl, iso-propyl, n-butyl, iso-butyl, sec-butyl, n-pentyl, iso-pentyl, neo-pentyl, iso-amyl, n-hexyl, 3-methylhexyl, 2,2-dimethylpentyl, 2,3-dimethylpentyl, and n-heptyl.

At least one hydrogen atom of the “alkyl” group may be substituted with a halogen atom, a C1-C20 alkyl group substituted with a halogen atom (e.g.: CCF₃, CHCF₂, CH₂F, or CCl₃), a C1-C20 alkoxy group, a C2-C20 alkoxyalkyl group, a hydroxy group, a nitro group, a cyano group, an amino group, an amidino group, a hydrazine group, a hydrazone group, a carboxylic acid or a salt thereof, a sulfonyl group, a sulfamoyl group, a sulfonic acid or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, a C7-C20 heteroarylalkyl group, a C6-C20 heteroaryloxy group, a C6-C20 heteroaryloxyalkyl group, and a C6-C20 heteroarylalkyl group.

As used herein, the term “a halogen atom” includes fluorine, bromine, chlorine, and iodine.

As used herein, the term “a C1-C20 alkyl group substituted with a halogen atom” refers to a C1-C20 alkyl group in which at least one halo group is substituted, and examples of the C1-C20 alkyl group substituted with a halogen atom may include monohaloalkyl, dihaloalkyl, or polyhaloalkyl including perhaloalkyl.

Monohaloalkyl refers to an alkyl group having one iodine, bromine, chlorine, or fluorine, and dihaloalkyl or polyhaloalkyl refers to an alkyl group having at least two halogen atoms that are identical to or different from each other.

As used herein, the term “alkoxy” refers to alkyl-O—, and the alkyl group is the same as defined above. Examples of the alkoxy group may include methoxy, ethoxy propoxy, 2-propoxy, butoxy, tert-butoxy, pentyloxy, hexyloxy, cyclopropoxy, and cyclohexyloxy. At least one hydrogen atom of the alkoxy group may be substituted with the same substituent groups as described above with reference to the alkyl group. In this regard, the term “alkoxy” includes a substituted alkoxy moiety.

As used herein, the term “alkoxyalkyl” refers to an alkyl group substituted by the alkoxy group described above. At least one hydrogen atom of the alkoxyalkyl may be substituted with the same substituent groups as described above with reference to the alkyl group. In this regard, the term “alkoxyalkyl” includes a substituted alkoxyalkyl moiety.

As used herein, the term “alkenyl” refers to a branched or unbranched hydrocarbon having at least one carbon-carbon double bond. Examples of the alkenyl group may include vinyl, allyl, butenyl, iso-propenyl, and iso-butenyl. At least one hydrogen of the alkenyl may be substituted with the same substituent groups as described above with reference to the alkyl group. In this regard, the term “alkenyl” includes a substituted alkenyl moiety.

As used herein, the term “alkynyl” refers to a branched or unbranched hydrocarbon having at least one carbon-carbon triple bond. Examples of the alkynyl group may include ethynyl, butynyl, iso-butynyl, and iso-propynyl.

At least one hydrogen of the alkynyl may be substituted with the same substituent groups as described above with reference to the alkyl group. In this regard, the term “alkynyl” includes a substituted alkynyl moiety.

As used herein, the term “aryl” is used alone or combined and refers to an aromatic hydrocarbon including at least one ring.

The term “aryl” refers to a group in which the aromatic ring is fused to at least one cycloalkyl ring.

Examples of the aryl may include phenyl, naphthyl, and tetrahydronaphthyl.

Also, at least one hydrogen atom of the aryl group may be substituted with the same substituent groups as described above with reference to the alkyl group. In this regard, the term “aryl” includes a substituted aryl moiety.

As used herein, the term “arylalkyl” refers to an alkyl substituted with aryl. Examples of arylalkyl include benzyl or phenyl-CH₂CH₂—. At least one hydrogen of the arylalkyl may be substituted with the same substituent groups as described above with reference to the alkyl group. In this regard, the term “arylalkyl” includes a substituted arylalkyl moiety.

As used herein, the term “aryloxy” refers to —O-aryl, and examples of the aryloxy include phenoxy. At least one hydrogen atom of the aryloxy group may be substituted with the same substituent groups as described above with reference to the alkyl group. In this regard, the term “aryloxy” includes a substituted aryloxy moiety.

As used herein, the term “heteroaryl” refers to a monocyclic or a bicyclic organic compound including at least one heteroatom selected from N, O, P, or S, and carbon as the remaining ring atoms. The heteroaryl group, for example, may include 1 to 5 hetero atoms, or 5 to 10 ring members, wherein S or N may be oxidized to various oxidation states.

At least one hydrogen atoms of the heteroaryl group may be substituted with the same substituent groups as described above with reference to the alkyl group. In this regard, the term “heteroaryl” includes a substituted heteroaryl moiety.

As used herein, the term “heteroarylalkyl” refers to an alkyl substituted with heteroaryl. At least one hydrogen of the heteroarylalkyl may be substituted with the same substituent groups as described above with reference to the alkyl group. In this regard, the term “heteroarylalkyl” includes a substituted heteroarylalkyl moiety.

As used herein, the term “heteroaryloxy” refers to —O-heteroaryl moiety. At least one hydrogen atom of the heteroaryloxy group may be substituted with the same substituent groups as described above with reference to the alkyl group. In this regard, the term “heteroaryloxy” includes a substituted heteroaryloxy moiety.

As used herein, the term “heteroaryloxyalkyl” refers to an alkyl substituted with heteroaryloxy. At least one hydrogen atom of the heteroaryloxyalkyl group may be substituted with the same substituent groups as described above with reference to the alkyl group. In this regard, the term “heteroaryloxyalkyl” includes a substituted heteroaryloxyalkyl moiety.

As used herein, the term “carbocyclic” refers to a fully or partially saturated or unsaturated non-aromatic monocyclic, bicyclic, or tricyclic hydrocarbon.

Examples of the monocyclic hydrocarbon may include cyclopentyl, cyclopentenyl, cyclohexyl, cyclohexyl, and cyclohexenyl; and examples of the bicyclic hydrocarbon may include bornyl, decahydronaphthyl, bicyclo[2.1.1]hexyl, bicyclo[2.2.1]heptyl, bicyclo[2.2.1]heptenyl, or bicyclo[2.2.2]octyl.

Examples of the tricyclic hydrocarbon may include adamantyl.

At least one carbocyclic group may be substituted with the same substituent groups as described above with reference to the alkyl group. In this regard, the term “carbocyclic” includes a substituted carbocyclic moiety.

As used herein, the term “carbocyclicoxy” refers to —O-carbocyclic moiety. At least one hydrogen atom of the carbocyclicoxy group may be substituted with the same substituent groups as described above with reference to the alkyl group. In this regard, the term “carbocyclicoxy” includes a substituted carbocyclicoxy moiety.

As used herein, the term “carbocyclicoxyalkyl” refers to a carbocyclic group substituted by the alkoxy group described above. At least one hydrogen atom of the carbocyclicoxyalkyl may be substituted with the same substituent groups as described above with reference to the alkyl group. In this regard, the term “carbocyclicoxyalkyl” includes a substituted carbocyclicoxyalkyl moiety.

As used herein, the term “heterocyclic” refers to a 5- to 10-membered ring group including a hetero atom, such as nitrogen, sulfur, phosphorus, or oxygen, and examples of the heteroring group may include pyridyl. At least one hydrogen atom of the heterocyclic group may be substituted with the same substituent groups as described above with reference to the alkyl group.

As used herein, the term “heterocyclicoxy” refers to a —O-heterocyclic group, and at least one hydrogen atom of the heterocyclicoxy group may be substituted with the same substituent groups as described above with reference to the alkyl group.

As used herein, the term “heterocyclicoxyalkyl” refers to a heterocyclic group substituted by the alkoxy group described above. At least one hydrogen atom of the heterocyclicoxyalkyl may be substituted with the same substituent groups as described above with reference to the alkyl group. In this regard, the term “heterocyclicoxyalkyl” includes a substituted heterocyclicoxyalkyl moiety.

As used herein, the term “sulfonyl” refers to R″—SO₂—, wherein R″ is a hydrogen, alkyl, aryl, heteroaryl, aryl-alkyl, heteroaryl-alkyl, alkoxy, aryloxy, cycloalkyl group, or heterocyclic group.

As used herein, the term “sulfamoyl” refers to H₂NS(O₂)—, alkyl-NHS(O₂)—, (alkyl)₂NS(O₂)-aryl-NHS(O₂)—, alkyl(aryl)-NS(O₂)—, (aryl)₂NS(O)₂, heteroaryl-NHS(O₂)—, (aryl-alkyl)-NHS(O₂)—, or (heteroaryl-alkyl)-NHS(O₂)—.

At least one hydrogen atom of the sulfamoyl group may be substituted with the same substituent groups as described above with reference to the alkyl group.

As used herein, the term “amino” refers to a nitrogen atom covalently bonded to at least one carbon or a hetero atom. An amino group includes, for example, —NH₂ and substituted moieties. Also, an amino group includes “alkylamino” in which a nitrogen atom is bonded to at least one additional alkyl group, or “diarylamino” in which nitrogen is bonded to at least one or two independently selected aryl groups.

Alkylene, arylene, and heteroarylene denote divalent groups derived from alkyl, aryl, and heteroaryl group, respectively.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1-C30 alkyl” refers to a C1-C30 alkyl group substituted with C6-C30 aryl group, the total number of carbon atoms in the resulting aryl substituted alkyl group is C7-C60.

A C rate is a discharge rate of a cell, and is obtained by dividing a total capacity of the cell by a total discharge period of time, e.g., a C rate for a battery having a discharge capacity of 1.6 ampere-hours would be 1.6 amperes.

Hereinafter, the electrolyte and the lithium metal battery according to exemplary embodiments of the present disclosure are described in more detail through the following Examples and Comparative Preparation Examples. However, such embodiments are provided for illustrative purposes only, and the scope of the present disclosure should not be limited thereto in any manner. Further, it should be understood that the present disclosure is not limited to the above descriptions since other various modifications of the present disclosure may be apparent to persons having ordinary knowledge in the related art pertinent to the present disclosure.

### EXAMPLES

### Preparation Example 1: Preparation of Liquid Electrolyte

Lithium bis(fluorosulfonyl)imide (LiFSI) as a lithium salt was mixed with ethylene glycol dimethyl ether (1,2-dimethoxyethane) (DME) and 1,1,2,2-tetrafluoroethyl-2,2,3,3-tetrafluoropropyl ether (TTE) at a volume ratio of 20:80 to prepare a 1 molar (M) solution of the lithium salt, and thus a liquid electrolyte was prepared by adding 0.5 part by weight of N-butyl-N-methylpyrrolidinium bis(fluorosulfonyl)imide (Pyr14FSI) thereto based on 100 parts by weight of an organic solvent as an additive to improve a deposition density.

### Preparation Example 2: Preparation of Liquid Electrolyte

A liquid electrolyte was prepared in the same manner as in Preparation Example 1, except that 0.5 part by weight of N-butyl-N-methylpyrrolidinium bis(trifluoromethanesulfonyl)imide (Pyr14TFSI) was added as an ionic liquid.

### Preparation Example 3: Preparation of Liquid Electrolyte

A liquid electrolyte was prepared in the same manner as in Preparation Example 1, except that 5 part by weight of N-butyl-N-methylpyrrolidinium bis(trifluoromethanesulfonyl)imide (Pyr14TFSI) was added as an ionic liquid.

### Comparative Preparation Example 1: Preparation of Liquid Electrolyte

A liquid electrolyte was prepared in the same manner as in Preparation Example 1, except that an ionic liquid was not added.

### Comparative Preparation Example 2: Preparation of Liquid Electrolyte

A liquid electrolyte was prepared in the same manner as in Preparation Example 1, except that 0.5 part by weight of 1-ethyl-3-methylimidazolium-bis(trifluoromethylsulfonyl)imide (EMITFSI) was added as an ionic liquid.

### Comparative Preparation Example 3: Preparation of Liquid Electrolyte

A liquid electrolyte was prepared in the same manner as in Preparation Example 1, except that 0.5 part by weight of N-propyl-N-methylpyridinium bis(fluorosulfonyl)imide (PPFSI) was added as an ionic liquid.

### Comparative Preparation Example 4: Preparation of Liquid Electrolyte

A liquid electrolyte was prepared in the same manner as in Preparation Example 1, except that 0.5 part by weight of N-methyl-N-propylpyrrolidinium bis(fluorosulfonyl)imide (Pyr13FSI) was added as an ionic liquid.

### Comparative Preparation Example 5: Preparation of Liquid Electrolyte

A liquid electrolyte was prepared in the same manner as in Preparation Example 1, except that 0.5 part by weight of N-methyl-N-propylpyrrolidinium bis(trifluoromethanesulfonyl)imide (Pyr13TFSI) was added as an ionic liquid.

### Comparative Preparation Example 6: Preparation of Liquid Electrolyte

A liquid electrolyte was prepared in the same manner as in Preparation Example 1, except that 0.5 part by weight of N-methoxyethyl-N-methylpyrrolidinium bis(trifluoromethanesulfonyl)imide (PYR_{12O1}TFSI) was added as an ionic liquid.

### Comparative Preparation Example 7: Preparation of Liquid Electrolyte

A liquid electrolyte was prepared in the same manner as in Preparation Example 1, except that 10 parts by weight of N-butyl-N-methylpyrrolidinium bis (trifluoromethanesulfonyl)imide (Pyr14TFSI) was added as an ionic liquid.

### Evaluation Example 1: Gel Permeation Chromatography (GPC) Analysis

A gel permeation chromatography (GPC) was performed on liquid electrolytes prepared in Preparation Example 2 and Comparative Preparation Examples 1 and 5. A GPC analysis device was Waters APC Acquity, and the system used for the analysis was Acquity APC XT45×3ea (4.6×150 millimeters (mm), 45A), and the chromatography was detected by an eluent of THF at UV of 254 nanometers (nm).

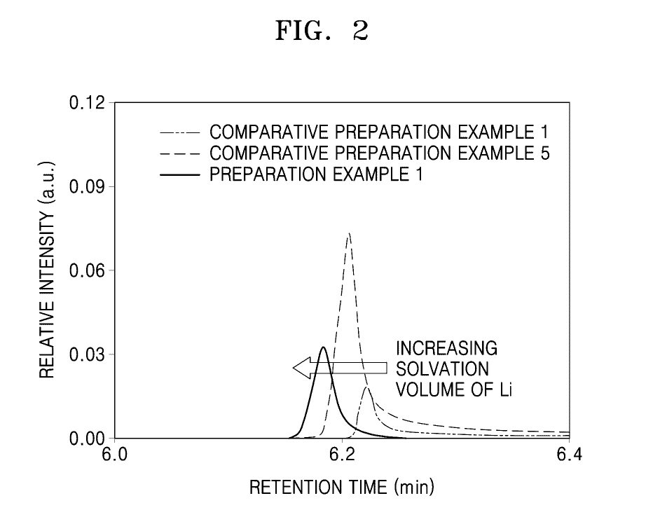

The results of the GPC analysis performed on the liquid electrolytes prepared in Preparation Example 2 and Comparative Preparation Examples 1 and 5 are shown in FIG. 2. As shown in FIG. 2, the liquid electrolyte including a pyrrolidinium ionic liquid had a reduced time for an eluent period, and this refers to an increase in volume solvation of lithium in the presence of the pyrrolidinium ionic liquid. Also, this indicates that when a length of chain increases, a volume solvation of lithium increases as well.

### Evaluation Example 2: Deposition Density Measurement

Test cells for measuring a deposition density of a lithium deposition layer formed by liquid electrolytes prepared in Preparation Examples 1 to 3 and Comparative Preparation Examples 1 to 7 were prepared as follows.

A 2-electrode cell of lithium-copper was prepared by disposing a polyethylene/polypropylene separator between a lithium metal electrode (having a thickness of about 20 micrometers (μm)) and a copper metal electrode (having a thickness of about 15 μm) and adding each of liquid electrolytes prepared in Preparation Examples 1 to 3 and Comparative Preparation Examples 1 to 7.

Li ions were deposited on a Cu electrode surface by using a constant current method, and a density of a lithium deposition layer was measured. Under a constant current condition, a thickness of the deposition layer was measured in micrometers, and an SEM image cross-sectional view analysis was conducted after depositing Li at a current density of 0.43 milliampere per square centimeter (mA/cm²) for 1 hour and at 4.3 mA/cm² for 1 hour on the Cu electrode.

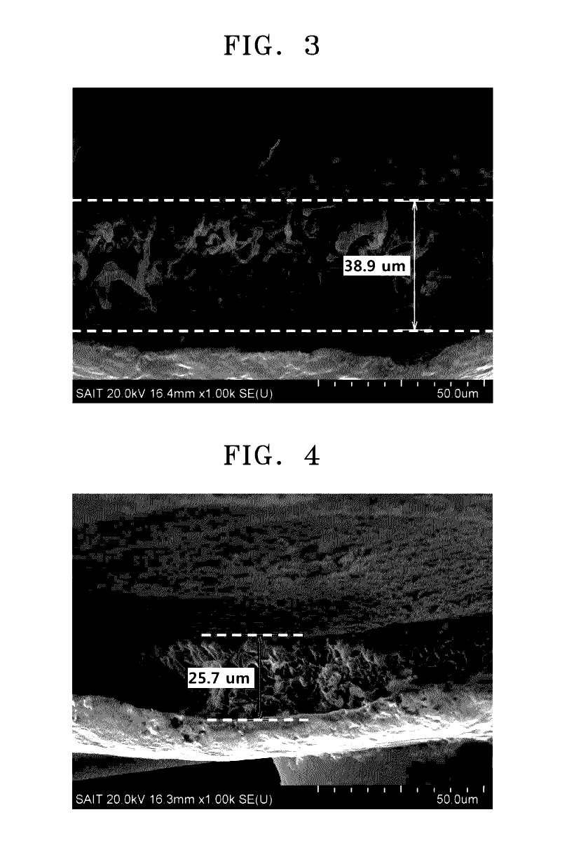

The SEM images of cross-sectional views of the lithium deposition layers when the electrolytes prepared in Comparative Preparation Example 1 and Preparation Example 2 are shown in FIGS. 3 and 4, respectively.

As shown in FIGS. 3 and 4, when the pyrrolidinium ionic liquid is added, a thin and compact deposition layer is formed.

Also, a deposition density was calculated by using the thickness of the disposition layer measured in the micrometers and a ratio of a thicknesses and a theoretical density of the deposition layer. The deposition density (%) of the deposition layer was calculated by following Equation 1. The results of the deposition density calculated by following Equation 1 are shown in Table 1.

$${ρ}_{d} = \frac{{d}_{th}}{{d}_{re}} 100 \qquad Equation 1$$

wherein,

ρ_{d} is a deposition density (percent, %) with respect to a lithium theoretical density of the lithium deposition layer,

dₜₕ is a theoretical thickness of the lithium deposition layer,

dᵣₑ is an actual thickness of the lithium deposition layer, and

dₜₕ is calculated according to Equation 2:

$${d}_{th} = \frac{{C}_{d}}{{C}_{th}} \frac{1}{{ρ}_{th} A} \qquad Equation 2$$

wherein,

Cₜₕ is a theoretical capacity of a lithium metal, which is 3,860 milliampere hours per gram (mAh/g),

ρₜₕ is a theoretical density of a lithium metal, which is 0.53 grams per cubic centimeter (g/cc),

A is a deposition area (square centimeters, cm²), and

C_{d} is a deposition capacity (milliampere hours, mAh).

TABLE 1

| | Deposition | Deposition | Deposition density vs |
|---|---|---|---|
| Liquid | thickness | layer density | lithium theoretical density |
| electrolyte | (μm) | (g/cc) | (%) |
| Preparation | 38.5 | 0.180 | 34.0% |
| Example 1 | | | |
| Preparation | 37 | 0.187 | 35.4% |
| Example 2 | | | |
| Preparation | 40 | 0.173 | 32.7% |
| Example 3 | | | |
| Comparative | 48 | 0.144 | 27.3% |
| Preparation | | | |
| Example 1 | | | |
| Comparative | 45 | 0.144 | 29.1% |
| Preparation | | | |
| Example 2 | | | |
| Comparative | 50 | 0.144 | 26.2% |
| Preparation | | | |
| Example 3 | | | |
| Comparative | 59 | 0.118 | 22.2% |
| Preparation | | | |
| Example 4 | | | |
| Comparative | 49 | 0.147 | 26.7% |
| Preparation | | | |
| Example 5 | | | |
| Comparative | 60 | 0.180 | 21.8% |
| Preparation | | | |
| Example 6 | | | |
| Comparative | 38 | 0.182 | 34.4% |
| Preparation | | | |
| Example 7 | | | |

As shown in Table 1, when an ionic liquid having a pyrrolidinium cation is added, a deposition density is relatively increased compared to the case when an ionic liquid having an imidazolium or piperidinium cation is added. Also, it was confirmed that, regardless of a type of an anion (FSI, TFSI), Pyr14, as a pyrrolidinium cation having 4 carbon atoms, improved a deposition density has been observed.

### Example 1: Preparation of Lithium Metal Battery

LiCoO₂, a conducting agent (Super-P; Timcal Ltd.), polyvinylidene fluoride (PVdF), and N-methylpyrrolidone were mixed to prepare a positive electrode composition. A mixing weight ratio of LiCoO₂, the conducting agent, PVdF, and N-methylpyrrolidone in the positive electrode composition was 97:1.5:1.5.

The positive electrode composition was coated on a top of an aluminum foil (having a thickness of about 15 μm) dried at 25° C., and the resultant was dried in vacuum at 110° C. to prepare a positive electrode.

A polyethylene/polypropylene separator was disposed between the positive electrode thus obtained and a lithium metal negative electrode (having a thickness of about 20 μm) to prepare a lithium metal battery (a coin cell), and the liquid electrolyte prepared in Preparation Example 1 was added thereto.

### Examples 2 and 3: Preparation of Lithium Metal Batteries

Lithium metal batteries were prepared in the same manner as in Example 1, except that the liquid electrolytes of Preparation Examples 2 and 3 were used instead of the liquid electrolyte of Preparation Example 1.

### Comparative Examples 1 to 7: Preparation of Lithium Metal Batteries

Lithium metal batteries were prepared in the same manner as in Example 1, except that the liquid electrolytes of Comparative Preparation Examples 1 to 7 were used instead of the liquid electrolyte of Preparation Example 1.

### Evaluation Example 3: Deposition Density Measurement

Lithium was deposited on the lithium metal negative electrodes prepared in Comparative Example 1 and Example 2 for 11 hours at 0.43 mA/cm², deposition density values thereof were measured, and the results are shown in Table 2. The deposition densities were calculated by following Equation 1.

TABLE 2

| | Deposition density |
|---|---|
| Comparative Example 1 | 29% |
| Example 1 | 34% |

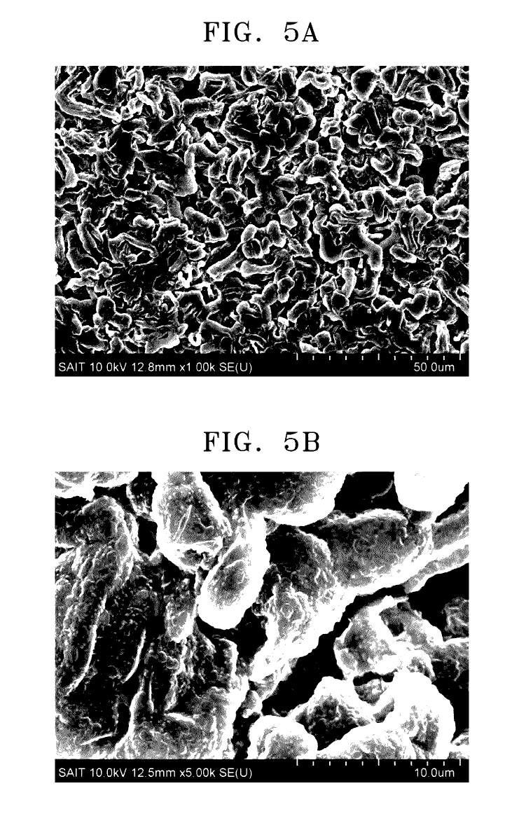

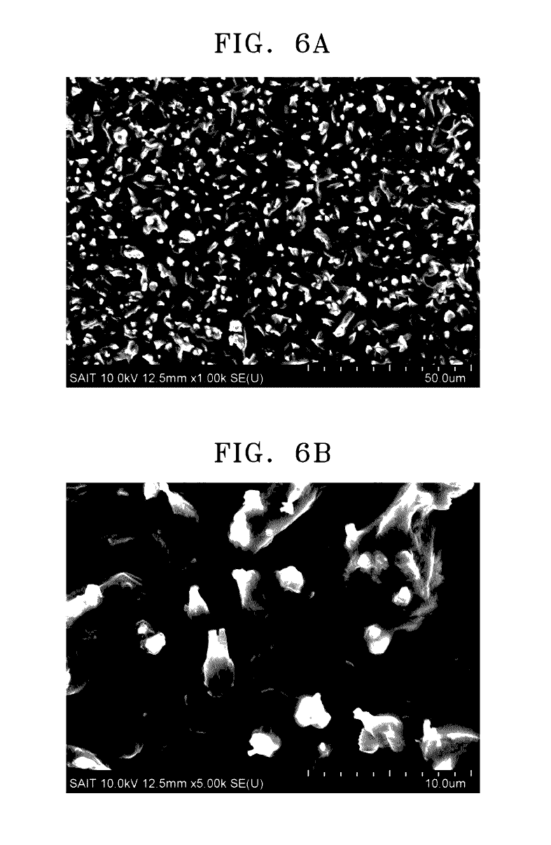

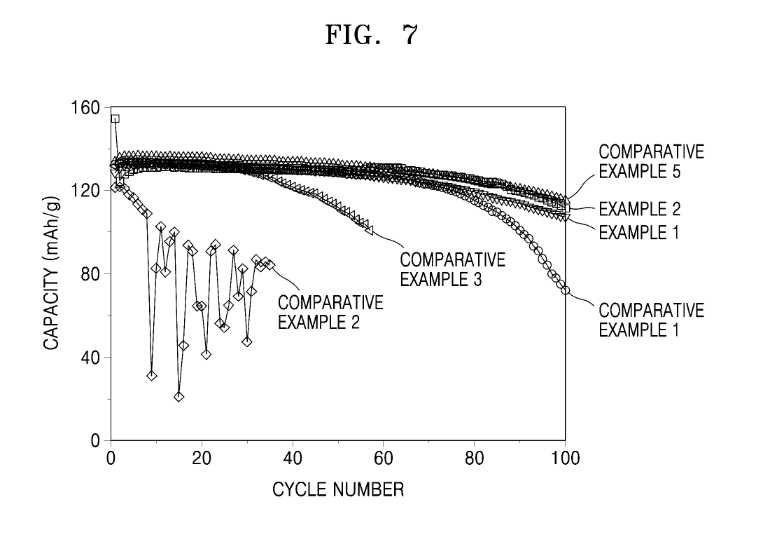

Also, an SEM image of the deposition layer of Comparative Example 1 is shown in FIGS. 5A and 5B; and the deposition layer of Example 2 is shown in FIGS. 6A and 6B.

As shown in Table 2, FIGS. 5A and 5B, and FIGS. 6A and 6B, when Pyr14TFSI ionic liquid is added, as well as in the case of the test cell using the Cu electrode, under the actual operation conditions, it may be confirmed that the deposition density improves. Also, as the surface analysis of the SEM image shows, tightness was observed as porosity of the lithium deposition layer recued.

### Evaluation Example 4: Charging/Discharging Characteristics

The lithium metal batteries of Examples 1 and 2 and Comparative Examples 1, 2, 3, and 5 were charged/discharged under the conditions as follows, and changes in charging/discharging characteristics per cycle were measured. The results are shown in FIG. 7.

Constant current charging processes of the lithium metal batteries were performed to a current of about 0.1 C rate at about 25° C. until a voltage reached about 4.30 volts (V) (vs. Li), and then the lithium metal batteries passing through the constant current charging processes were cutoff at a current of about 0.05 C rate while maintaining the voltage of about 4.30 V in a constant voltage mode. Subsequently, the cutoff lithium metal batteries were discharged to a constant current of about 0.1 C rate until the voltage reached about 2.8 V (vs. Li) during discharging (the first cycle in the chemical conversion step). Such charging and discharging process was performed for two more cycles to complete the chemical conversion step.

After the chemical conversion step, the lithium metal batteries were charged with a constant current of i) about 0.5 C rate or ii) 1 C rate at about room temperature (25° C.) in a voltage range of about 3.0 V to about 4.4 V, and then the lithium metal batteries passing through the constant current discharging processes were performed to a constant current of about 0.2 C rate by a current of about 0.72 mA until the voltage reached about 4.4 V of a cutoff voltage.

The charging and discharging process was performed for 99 more cycles to complete the total of 100 cycles.

As shown in FIG. 7, it may be confirmed that when the pyrrolidinium ionic liquid is added, lifespan stability of the battery improved.

### Evaluation Example 5: Impedance Measurement

Resistances of the lithium metal batteries prepared in Comparative Example 1 and Examples 1 and 2 were measured by using an impedance analyzer (SOLARTRON 1260A Impedance/Gain-Phase Analyzer) using a 2-probe method at 25° C. An amplitude was ±10 millivolts (mV), and a frequency range was about 0.1 Hertz (Hz) to about 1 megaHertz (MHz).

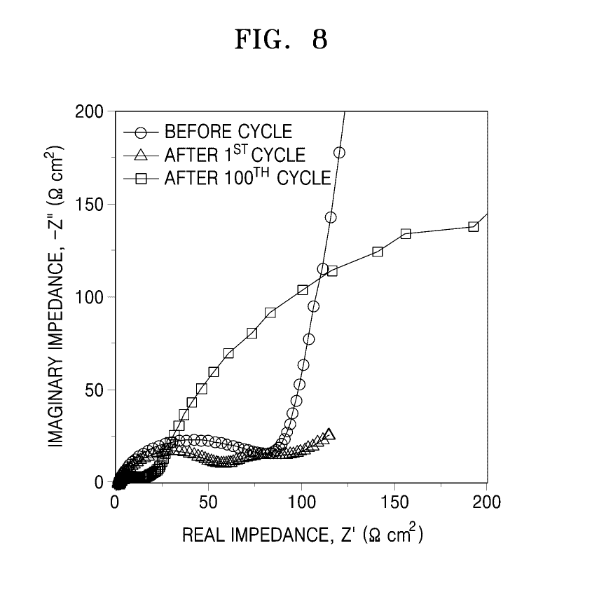

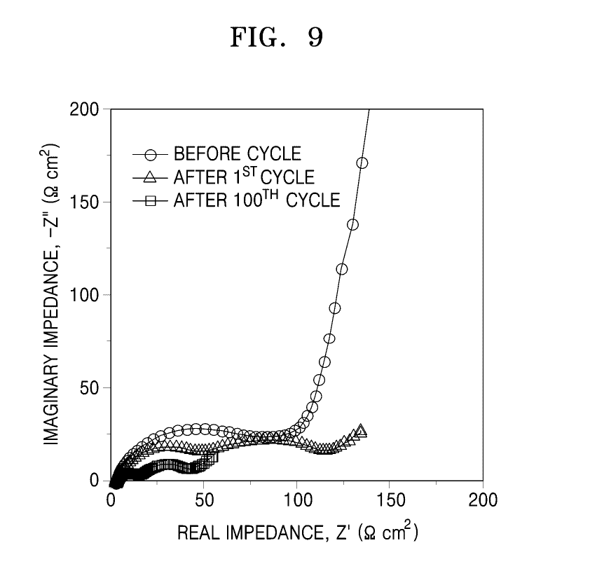

The lithium metal batteries prepared in Comparative Example 1 and Examples 1 and 2 were charged and discharged in the same manner as described in Evaluation Example 4, and the impedance measurement results after the first cycle and the 100^{th} cycle of the Nyquist plots are shown in FIGS. 8 and 9. The interfacial resistances of the electrode shown in FIGS. 8 and 9 are determined by locations and sized of the semicircle. The difference between a left x-intercept and a right x-intercept of the semicircle denotes an interfacial resistance of the electrode.

As shown in FIGS. 8 and 9, it may be confirmed that when the pyrrolidinium ionic liquid is added, the interfacial resistance is reduced as the number of cycles increases. In this regard, it may be known that interfacial stability increases by addition of the pyrrolidinium ionic liquid.

### Evaluation Example 6: Characteristic Analysis According to Addition Amount of Ionic Liquid

(1) Charging/Discharging Characteristic Evaluation

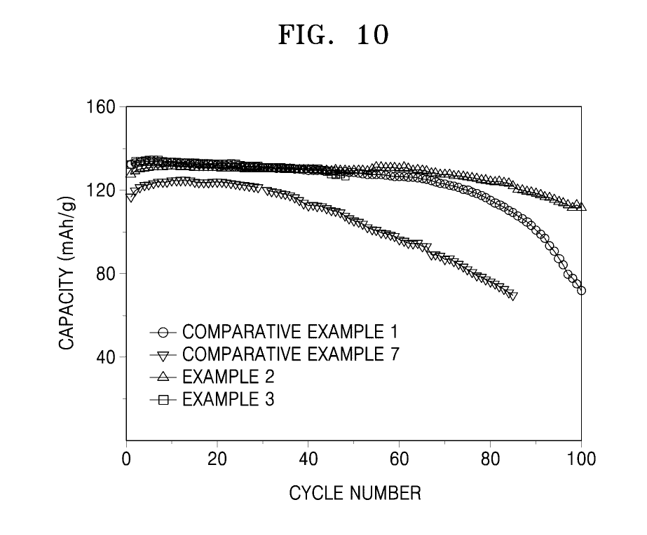

The lithium metal batteries of Comparative Examples 1 and 7 and Examples 2 and 3 2343 charged and discharged in the same manner as described in Evaluation Example 4, and changes in discharge capacities per cycle are shown in FIG. 10.

Also, the results of evaluating initial capacities and capacity retention ratios at 50^{th} cycle of the lithium metal batteries are shown in Table 3. The capacity retention ratio may be calculated by following Equation 3.

Capacity retention ratio (%)=(Discharge capacity at 50^{th} cycle/discharge capacity at 1^{st} cycle)×100 Equation 3

TABLE 3

| | Initial capacity | Capacity retention |
|---|---|---|
| | (mAh) | ratio at 50th cycle |
| Comparative Example 1 | 132.4 | 96% |
| Example 2 | 127.7 | 99.5% |
| Example 3 | 132.4 | 95% |
| Comparative Example 7 | 117 | 87% |

As shown in FIG. 10 and Table 3, when Pyr14TFSI was increased to 10 percent by weight (wt %), it may be seen that the lifespan rapidly decreased after the 30^{th} cycle. Thus, an additive for improving a deposition density needs to be maintained at an amount of 3 parts by weight or lower.

(2) Impedance Evaluation

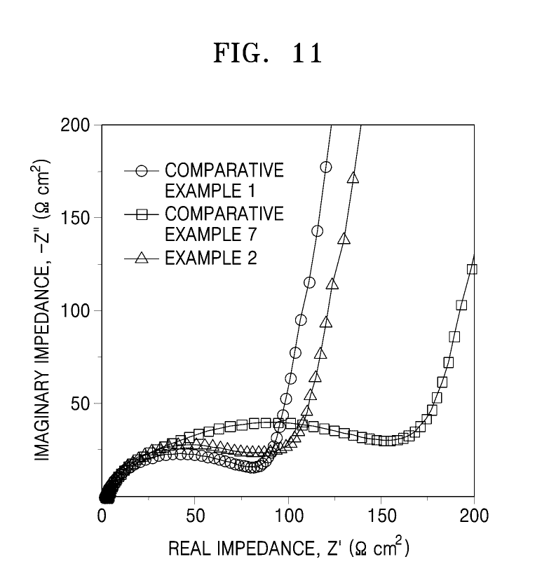

The lithium metal batteries of Comparative Examples 1 and 7 and Example 2 were charged and discharged for 50 cycles, and impedances thereof were measured in the same manner as described in Evaluation Example 4. The results are shown in FIG. 11.

As shown in FIG. 11, when Pyr14TFSI was increased to 10 wt %, it may be seen that a surface resistance increases, and thus an interfacial stability decreases.

As described above, a lithium metal battery according to the one or more of the above embodiments includes an ionic liquid for improving a deposition density, which increases an energy density during charging by increasing a density of a lithium deposition layer at a surface of a lithium metal negative electrode, and thus a side reaction of a liquid electrolyte is minimized during charging/discharging so that lifespan characteristics of the battery may improve.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present disclosure as defined by the following claims.

What is claimed is:

1. A lithium metal battery comprising:
a lithium metal negative electrode;
a positive electrode; and
a liquid electrolyte disposed between the lithium metal negative electrode and the positive electrode,
wherein the liquid electrolyte comprises
an ionic liquid comprising a cation represented by Formula 1 and an anion, and
an organic solvent: 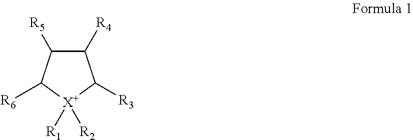
wherein in Formula 1,
X is N, P, or As;
R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ comprises 4 or more carbon atoms; and
R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclicalkyl group, a substituted or unsubstituted C2-C30 heterocyclicoxy group, or a substituted or unsubstituted C3-C30 heterocyclicoxyalkyl group.

2. The lithium metal battery of claim 1, wherein the cation is a pyrrolidinium cation represented by Formula 2: 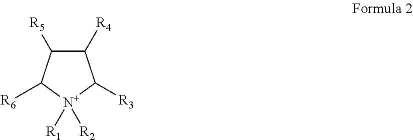
wherein in Formula 2,
R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ comprises 4 or more carbon atoms; and
R₃ to R₆ are each independently a hydrogen atom, a halogen atom, a cyano group, a substituted or unsubstituted C1-C30 alkyl group, a substituted or unsubstituted C2-C30 alkenyl group, a substituted or unsubstituted C2-C30 alkynyl group, a substituted or unsubstituted C6-C30 aryl group, a substituted or unsubstituted C1-C30 alkoxy group, a substituted or unsubstituted C2-C30 alkoxyalkyl group, a substituted or unsubstituted C6-C30 aryloxy group, a substituted or unsubstituted C7-C30 aryloxyalkyl group, a substituted or unsubstituted C7-C30 arylalkyl group, a substituted or unsubstituted C2-C30 heteroaryl group, a substituted or unsubstituted C2-C30 heteroaryloxy group, a substituted or unsubstituted C3-C30 heteroarylalkyl group, a substituted or unsubstituted C4-C30 carbocyclic group, a substituted or unsubstituted C5-C30 carbocyclicalkyl group, a substituted or unsubstituted C4-C30 carbocyclicoxy group, a substituted or unsubstituted C5-C30 carbocyclicoxyalkyl group, a substituted or unsubstituted C2-C30 heterocyclic group, or a substituted or unsubstituted C3-C30 heterocyclic alkyl group, a substituted or unsubstituted C2-C30 heterocyclicoxy group, or a substituted or unsubstituted C3-C30 heterocyclicoxyalkyl group.

3. The lithium metal battery of claim 1, wherein the cation is a pyrrolidinium cation represented by Formula 2a: 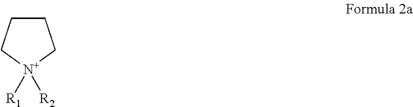
wherein in Formula 2a,
R₁ and R₂ are each independently a hydrogen, a substituted or unsubstituted C1-C30 alkyl group, a substituted or unsubstituted C4-C30 carbocyclic group, a substituted or unsubstituted C5-C30 carbocyclicalkyl group, or a substituted or unsubstituted C2-C30 alkenyl group, wherein at least one of R₁ and R₂ comprises 4 or more carbon atoms.

4. The lithium metal battery of claim 1, wherein at least one hydrogen atom of R₁ to R₆ is substituted with a halogen atom, a C1-C30 alkyl group substituted with a halogen atom, a C1-C30 alkoxy group, a C2-C30 alkoxyalkyl group, a hydroxyl group, a nitro group, a cyano group, an amino group, an amidino group, a hydrazine group, a hydrazone group, a carboxylic acid or a salt thereof, a sulfonyl group, a sulfamoyl group, a sulfonic acid or a salt thereof, a phosphoric acid or a salt thereof, a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C3-C30 heteroaryloxyalkyl group, a C6-C30 heteroarylalkyloxy group, a C4-C30 carbocyclic group, a C5-C30 carbocyclicalkyl group, a C4-C30 carbocyclicoxy group, a C5-C30 carbocyclicoxyalkyl group, a C2-C30 heterocyclic group, or a C3-C30 heterocyclic alkyl group, a C2-C30 heterocyclicoxy group, or a C3-C30 heterocyclicoxyalkyl group.

5. The lithium metal battery of claim 1, wherein the cation comprises at least one selected from N-butyl-N-methylpyrrolidinium, N-methyl-N-pentylpyrrolidinium, N-hexyl-N-methylpyrrolidinium, N-heptyl-N-methylpyrrolidinium, N-methyl-N-octylpyrrolidinium, N-methyl-N-nonylpyrrolidinium, N-decyl-N-methylpyrrolidinium, N-methyl-N-undecylpyrrolidinium, N-dodecyl-N-methylpyrrolidinium, N-methyl-N-tridecylpyrrolidinium, N-methyl-N-tetradecylpyrrolidinium, N-methyl-N-pentadecylpyrrolidinium, N-hexadecyl-N-methylpyrrolidinium, N-heptadecyl-N-methylpyrrolidinium, N-methyl-N-octadecylpyrrolidinium, N-methyl-N-nonadecylpyrrolidinium, N-eicosyl-N-methylpyrrolidinium, N-butyl-N-ethylpyrrolidinium, N-butyl-N-propylpyrrolidinium, N, N-dibutylpyrrolidinium, N-butyl-N-pentylpyrrolidinium, N-butyl-N-hexylpyrrolidinium, N-butyl-N-heptylpyrrolidinium, N-butyl-N-octylpyrrolidinium, N-butyl-N-nonylpyrrolidinium, and N-butyl-N-decylpyrrolidinium.

6. The lithium metal battery of claim 1, wherein an amount of the cation of the ionic liquid is from greater than 0 parts by weight to about 3 parts by weight, based on 100 parts by weight of the organic solvent.

7. The lithium metal battery of claim 1, wherein an amount of the cation of the ionic liquid is from greater than 0 parts by weight to about 2 parts by weight, based on 100 parts by weight of the organic solvent.

8. The lithium metal battery of claim 1, wherein the anion is at least one selected from BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₃C⁻, NO₃⁻, CH₃COO⁻, Cl⁻, Br⁻, I⁻, SO₄⁻, CF₃SO₃⁻, (C₂F₅SO₂)₂N⁻, C₂F₅SO₂)(CF₃SO₂)N⁻, (CF₃)₂PF₄⁻, (CF₃)₃PF₃⁻, (CF₃)₄PF₂⁻, (CF₃)₅PF⁻, CF₃)₆P⁻, SF₅CF₂SO₃⁻, SF₅CHFCF₂SO₃⁻, CF₃CF₂(CF₃)₂CO⁻, (CF₃SO₂)₂CH⁻, SF₅)₃C⁻, (O(CF₃)₂C₂(CF₃)₂O)₂PO⁻, (FSO₂)₂N⁻, and (CF₃SO₂)₂N⁻.

9. The lithium metal battery of claim 1, wherein the organic solvent comprises an ether solvent.

10. The lithium metal battery of claim 1, wherein the organic solvent comprises:
an ether solvent in which lithium ions are solvated, and
a fluorine-substituted ether solvent represented by Formula 3:
R—{O(CH₂)ₐ}_{b}—CH₂—O—CₙF₂ₙH Formula 3
wherein in Formula 3,
R is a of the formula CₘF₂ₘH or CₘF₂ₘ₊₁,
n is an integer of 2 or greater,
m is an integer of 1 or greater,
a is an integer of 1 or 2, and
b is 0 or 1.

11. The lithium metal battery of claim 10, wherein an amount of the fluorine-substituted ether solvent represented by Formula 3 is greater than an amount of the ether solvent in which lithium ions are solvated.

12. The lithium metal battery of claim 11, wherein an amount of the ether solvent in which lithium ions are solvated is in a range of about 15 percent by volume to about 45 percent by volume, and the amount of the fluorine-substituted ether solvent represented by Formula 1 is in an amount range of about 55 percent by volume to about 85 percent by volume.

13. The lithium metal battery of claim 10, wherein the fluorine-substituted ether solvent is a compound represented by Formula 4:
R—CH₂—O—CₙF₂ₙH
wherein in Formula 4, R is Cₘ₊₁ HₘF₂ₘ or CₘF₂ₘ₊₁,
n is an integer of 2 to 5, and
m is an integer of 1 to 5.

14. The lithium metal battery of claim 10, wherein the fluorine-substituted ether solvent represented by Formula 4 is at least one selected from HCF₂CF₂CH₂OCF₂CF₂H, HCF₂CF₂CH₂OCF₂CF₂CF₂CF₂H, HCF₂CF₂OCH₂CF₃, HCF₂CF₂OCH₂CH₂OCF₂CF₂H, HCF₂CF₂OCH₂CH₂OCF₂CF₂H, HCF₂CF₂OCH₂CH₂CH₂OCF₂CF₂H, HCF₂CF₂CH₂OCF₂CF₂CF₂H, HCF₂CF₂OCH₂CH₂OCF₂CF₂CF₂H, and HCF₂CF₂OCH₂CH₂CH₂OCF₂CF₂CF₂H.

15. The lithium metal battery of claim 10, wherein the ether solvent in which lithium ions are solvated is a glyme solvent.

16. The lithium metal battery of claim 10, wherein the ether solvent in which lithium ions are solvated is at least one selected from ethylene glycol dimethyl ether, ethylene glycol diethyl ether, propylene glycol dimethyl ether, propylene glycol diethyl ether, butylene glycol dimethyl ether, butylene glycol diethyl ether, diethylene glycol dimethyl ether, triethylene glycol dimethyl ether, tetraethylene glycol dimethyl ether, diethylene glycol diethyl ether, triethylene glycol diethyl ether, tetraethylene glycol diethyl ether, dipropylene glycol dimethyl ether, tripropylene glycol dimethyl ether, tetrapropylene glycol dimethyl ether, dipropylene glycol diethyl ether, tripropylene glycol diethyl ether, tetrapropylene glycol diethyl ether, dibutylene glycol dimethyl ether, tributylene glycol dimethyl ether, tetrabutylene glycol dimethyl ether, dibutylene glycol diethyl ether, tributylene glycol diethyl ether, tetrabutylene glycol diethyl ether, poly(ethyleneglycol) dilaurate, poly(ethyleneglycol) monoacrylate, and poly(ethyleneglycol) diacrylate.

17. The lithium metal battery of claim 1, wherein the organic solvent further comprises at least one selected from ethylene carbonate, propylene carbonate, dimethyl carbonate, diethyl carbonate, butylene carbonate, ethylmethyl carbonate, fluoroethylene carbonate, methylpropyl carbonate, ethylpropyl carbonate, methylisopropyl carbonate, dipropyl carbonate, dibutyl carbonate, gamma butyrolactone, dimethylene glycol dimethyl ether, trimethylene glycol dimethyl ether, tetraethylene glycol dimethyl ether, polyethylene glycol dimethyl ether, succinonitrile, dimethyl sulfone, ethylmethyl sulfone, diethyl sulfone, adiponitrile, 1,1,2,2-tetrafluoroethyl-2,2,3,3-tetrafluoropropyl ether, 2,3,3,4,4,5,5-octafluoropentyl-1,1,2,2-tetrafluoroethyl ether, benzonitrile, acetonitrile, tetrahydrofuran, 2-methyltetrahydrofuran, γ-butyrolactone, dioxolane, 4-methyldioxolane, N,N-dimethylformamide, N,N-dimethylacetamide, dimethyl sulfoxide, dioxane, sulfolane, dichloroethane, chlorobenzene, and nitrobenzene.

18. The lithium metal battery of claim 1, wherein the electrolyte further comprises at least one lithium salt selected from LiSCN, LiN(CN)₂, LiClO₄, LiBF₄, LiAsF₆, LiPF₆, LiCF₃SO₃, Li(CF₃SO₂)₂N, Li(CF₃SO₂)₃C, LiSbF₆, LiN(SO₂CF₃)₂, Li(FSO₂)₂N, LiC₄F₉SO₃, LiN(SO₂CF₂CF₃)₂, LiSbF₆, LiPF₃(CF₂CF₃)₃, LiPF₃(C₂F₅)₃, LiPF₃(CF₃)₃, LiCl, LiF, LiBr, LiI, LiB(C₂O₄)₂, lithium difluoro(oxalato)borate, and lithium bis(oxalato)borate.

19. The lithium metal battery of claim 18, wherein an amount of the lithium salt is in a range of about 0.1 mole per liter to about 7 moles per liter.

20. The lithium metal battery of claim 1 further comprising a lithium deposition layer disposed on a surface of the lithium metal negative electrode.

21. The lithium metal battery of claim 20, wherein a deposition density of the lithium deposition layer calculated according to Equation 1 is 30% or greater:
$${ρ}_{d} = \frac{{d}_{th}}{{d}_{re}} 100 \qquad Equation 1$$
wherein
ρ_{d} is a deposition density with respect to a lithium theoretical density of the lithium deposition layer,
dₜₕ is a theoretical thickness of the lithium deposition layer,
dᵣₑ is an actual thickness of the lithium deposition layer, and
dₜₕ is calculated according to Equation 2:
$${d}_{th} = \frac{{C}_{d}}{{C}_{th}} \frac{1}{{ρ}_{th} A} \qquad Equation 2$$
wherein
Cₜₕ is a theoretical capacity of a lithium metal, which is 3,860 milliampere hours per gram,
ρₜₕ is a theoretical density of a lithium metal, which is 0.53 grams per cubic centimeter,
A is a deposition area expressed in square centimeters, and
C_{d} is a deposition capacity expressed in milliampere hours.
